(19) United States
(12) Patent Application Publication
(10) Pub. No.: US 2024/0100755 A1
(43) Pub. Date: Mar. 28, 2024

(54) APPARATUS AND METHOD FOR THE PRODUCTION OF FOAMED POLYMERIC MATERIAL

(71) Applicant: FAP S.R.L., Besana in Brianza (MB) (IT)

(72) Inventors: Francesco POLI, Besana in Brianza (MB) (IT); Fabrizio POLI, Besana in Brianza (MB) (IT); Alexandre DYMINSKI, Besana in Brianza (MB) (IT)

(73) Assignee: FAP S.R.L., Besana in Brianza (MB) (IT)

(21) Appl. No.: 18/257,408

(22) PCT Filed: Dec. 16, 2021
(86) PCT No.: PCT/IB2021/061843

§ 371 Date: Jun. 14, 2023

(30) Foreign Application Priority Data
Dec. 21, 2020 (IT) 102020000031685

(51) Int. Cl. B29C 48/00; B29C 48/41; B29C 48/535; B29C 48/80; C08J 9/12

(52) U.S. Cl. CPC B29C 48/0012; B29C 48/41; B29C 48/535; B29C 48/802; C08J 9/122; B29C 2791/001; B29K 2023/06; B29K 2023/12

(57) ABSTRACT

An apparatus having an extrusion machine and a feeding unit. for producing foamed polymeric material, in particular polyethylene and polypropylene, is disclosed. The extrusion machine includes a cylindrical barrel which is connected with a first end thereof to the feeding unit to receive a blend of plastic material to be extruded, a parallel pair of screws in the cylindrical barrel, a driving unit for driving the screws into rotation in opposite directions, a gas tank containing CO₂ as a foaming gas, injection means for injecting the foaming gas into the cylindrical barrel; a head mounted at a second end of the cylindrical barrel opposite to the first end and heating means arranged around the cylindrical barrel for transferring heat thereto.

### TECHNICAL FIELD

The present invention refers to an apparatus and a method for the production of foamed polymeric material, in particular polyethylene (PE) and polypropylene (PP).

### STATE OF THE ART

It is known that polyethylene foam and propylene foam can be obtained by means of a physical foaming process or by means of a chemical foaming process.

The physical foaming process is carried out in an apparatus comprising an extrusion machine extending horizontally. A molten mass of the starting plastic material is caused to move forward by means of a rotating screw in a cylindrical barrel of the extrusion machine and a foaming gas, in particular isobutane, is injected into this molten mass. Finally, the mass of material is caused to flow out of the cylindrical barrel of the extrusion machine through a head having an outlet opening suitably shaped so as to determine the shape and thickness of the material. Cellulation of the material occurs due to the pressure drop that the mass of material encounters upon contact with the external environment.

A shortcoming of the technology currently used for the production of polyethylene foam and propylene foam is the production of a material with high density (typically higher than 100 kg/m³), therefore oversized compared to the characteristics required in the fields where this material is typically used, for example the packaging field and the thermal or acoustic insulation field.

Furthermore, the use of isobutane as a foaming gas for the production of polyethylene foam and polypropylene foam entails a series of drawbacks, related to the high cost and flammability of this gas, as well as the long degassing time of the material required by the use of this gas.

### SUMMARY OF THE INVENTION

It is an object of the present invention to provide an apparatus and a method for the production of foamed polymeric material, in particular polyethylene and polypropylene, that allow to overcome the drawbacks of the prior art discussed above.

In particular, the present invention aims at providing an apparatus and a method that allow to obtain foamed polymeric material with a density lower than the density currently obtainable, in particular lower than 100 kg/m³.

Furthermore, the present invention aims at providing an apparatus and a method that allow to produce foamed polymeric material at lower costs and with lower risks than the apparatuses and methods currently used.

These and other objects are fully achieved, according to an aspect of the present invention, by virtue of an apparatus as defined in the enclosed independent claim 1 and, according to a further aspect of the present invention, by virtue of a method as defined in the enclosed independent claim 9.

Preferred embodiments of the apparatus, as well as preferred modes for carrying out the method, according to the present invention are the subject-matter of the dependent claims.

In summary, the invention is based first of all on the idea of using carbon dioxide (CO₂), instead of isobutane, as a foaming gas to be injected into the molten mass of plastic material which is caused to move forward inside the cylindrical barrel of the extrusion machine.

Thanks to the use of CO₂ as a foaming gas, it has been shown that it is possible to obtain a foamed material with a density lower than 100 kg/m³, in particular lower than 85 kg/m³, for example about 80 kg/m³. Furthermore, since CO₂ is a much less expensive gas than isobutane (its cost is, in fact, on average equal to one tenth of that of isobutane) and since, for the same quantity of foamed material produced, a lower quantity (approximately half the quantity) of CO₂ than isobutane is required, a considerable saving is obtained in terms of costs for producing the material. Furthermore, CO₂ is not flammable, so there is no risk of fire or explosion throughout the production method. Another advantage is that, by using CO₂ as a foaming gas, the degassing time of the material is reduced to a few hours (compared to the at least seven days required in the case of using isobutane), so that the foamed material thus produced can be used after only a few hours from its production.

According to an aspect of the invention, the extrusion machine comprises a pair of counter-rotating screws which are arranged, with their respective axes parallel to each other, inside a cylindrical barrel of the extrusion machine and are suitably configured to mix and push forward the material fed to the extrusion machine from the feeding area towards the head, through which the material flows out of the extrusion machine. In particular, the screws have threaded lengths with different pitches from each other, as well as threaded lengths with variable pitch, so that each threaded length of the screw is specifically configured to perform a given function.

The cylindrical barrel of the extrusion machine is heated, for example by means of electrical resistances placed outside the body. The control system of the extrusion machine properly controls the temperature, as well as the pressure, in the cylindrical body, in particular in a differentiated way according to the area of the cylindrical barrel along the direction of advancement of the material, in order to ensure that a foamed material is produced which has the desired properties.

Further characteristics and advantages of the present invention will become evident from the following detailed description, given purely by way of non-limiting example.

### BRIEF DESCRIPTION OF THE DRAWINGS

In the following detailed description of the invention, reference will be made to the Figures of the enclosed drawings, where:

FIG. 1 is a schematic side view generally showing an apparatus for the production of foamed polymeric material according to an embodiment of the present invention;

FIG. 2 shows the cylindrical barrel of the extrusion machine of the apparatus of FIG. 1;

FIG. 3 shows the outlet end of the cylindrical barrel of FIG. 2, together with the head of the extrusion machine of the apparatus of FIG. 1; and

FIG. 4 shows one of the two counter-rotating screws of the extrusion machine of the apparatus of FIG. 1.

### DETAILED DESCRIPTION

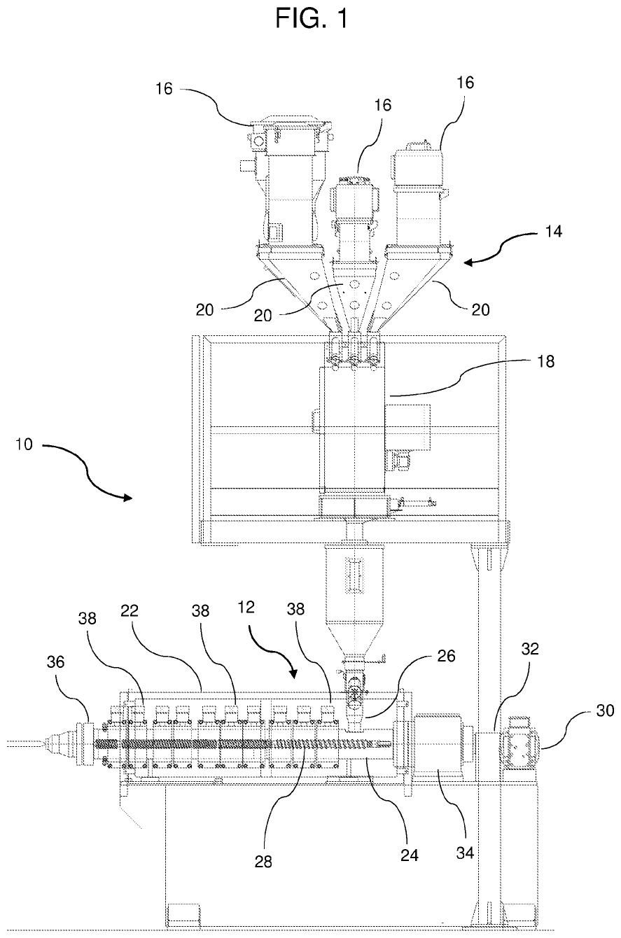

With reference initially to FIG. 1, an apparatus for the production of foamed polymeric material, in particular polyethylene and polypropylene, by means of a physical foaming process is generally indicated 10.

The apparatus 10 comprises an extrusion machine 12 and a feeding unit 14 for feeding the extrusion machine 12 with the raw material necessary for the production of the desired foamed polymeric material. Any further units of the apparatus located downstream of the extrusion machine to collect and treat the material flowing out of the machine are not described here, but are in any case of a type known per se and therefore well known to those skilled in the art.

The feeding unit 14 comprises a series of dosing stations 16 (the number of which is variable, for example, between a minimum of four and a maximum of eleven) and an underlying collection chamber 18. Each dosing station 16 is designed to dose a given quantity of raw material and feed it through a respective hopper 20 to the collection chamber 18, where the blend of plastic material to be introduced into the extrusion machine 12 is formed. Depending on the material to be produced, the various dosing stations 16 supply raw material to the collection chamber 18 with a given flow rate, which may for example vary from a few tens of kg/h to several hundreds of kg/h, in particular from 25 kg/h to 1500 kg/h.

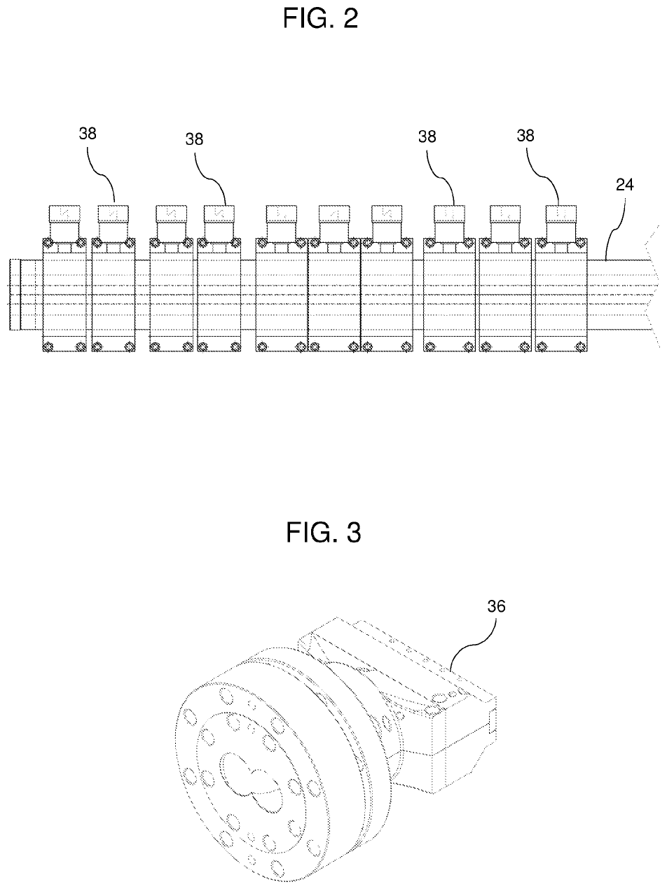

With reference also to FIGS. 2 and 3, the extrusion machine 12 basically comprises a machine body 22, a cylindrical barrel 24 accommodated in the machine body 22 and extending with its own longitudinal axis (indicated with x) horizontally, a fitting 26 through which the collection chamber 18 of the feeding unit 14 is connected to the cylindrical barrel 24 to introduce into the latter the blend of plastic material to be extruded, a pair of counter-rotating screws 28 (only one of which is shown in the drawings) received in the cylindrical barrel 24, a driving unit (comprising, for example, in a per-se-known way, an electric motor 30 connected by means of a coupling 32 to a splitter reducer 34) for driving the screws 28 into rotation at the same speed, but in opposite directions, around the respective axes (arranged parallel to each other), an injection device (not shown, but in any case of a type known per se) for injecting foaming gas (stored in a special gas tank of the apparatus, also not shown) into the cylindrical barrel 24, a head 36 mounted at the outlet end of the cylindrical barrel 24, and a plurality of heating elements 38 (only some of which are indicated with a reference line in the drawings) arranged around the cylindrical barrel 24 to transfer heat thereto.

The operating principle of the extrusion machine 12 is the same as that of the known extrusion machines. The extrusion machine 12 receives the blend of plastic material to be extruded from the feeding unit 14 through the fitting 26. The plastic material inside the cylindrical barrel 24 is melted and caused to move forward by the screws 28 along the cylindrical barrel 24 towards the head 36. Furthermore, in a longitudinally intermediate region of the cylindrical barrel 24 the injection device injects into the barrel the foaming gas coming from the gas tank. In this regard, as will be further explained in the remaining part of the description, according to the invention carbon dioxide (CO₂) is used as foaming gas, instead of isobutane.

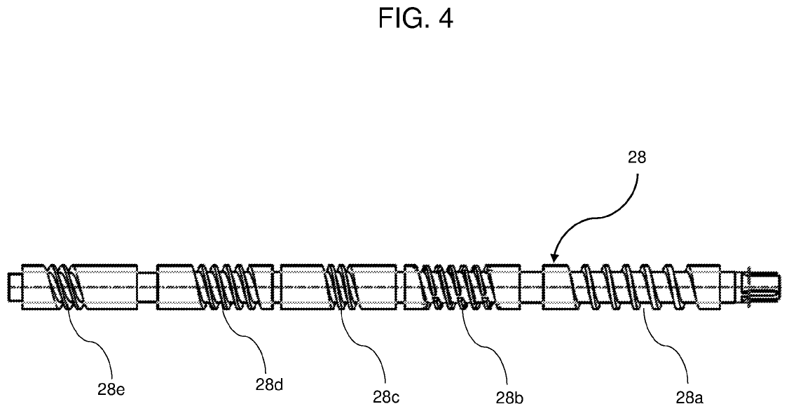

With reference to FIG. 4, each screw 28 comprises threaded lengths having different configurations with respect to each other, each of these lengths being able to perform a very specific function depending on the position of the material along the cylindrical barrel 24. For simplicity, each of these threaded lengths is only partially shown in FIG. 4, in that the threading of each threaded length is drawn only for a portion of the axial extension of this length.

More specifically, each screw 28 comprises first of all, in the direction from the feeding area to the outlet area of the plastic material, a first threaded length 28a configured to allow the plastic material to be mixed and melted completely. In particular, in the first threaded length 28a the threading has a variable pitch, for example from 19 to 30 mm. In the first threaded length 28a of the screw 28 a higher temperature of the cylindrical barrel 24 is ensured by the heating element (or by the heating elements) 38 with respect to the outlet area of the plastic material, so as to facilitate the melting of the material. In particular, a temperature between 180 and 240° C. is maintained in this region of the cylindrical barrel 24. The pressure in this region of the cylindrical barrel 24 varies between 70 and 190 bar and is monitored by pressure sensors (not shown in detail, but in any case of a type known per se).

Each screw 28 further comprises a second threaded length 28b in which the threading has a smaller pitch than the first threaded length 28a so as to reduce the space through which the material is allowed to flow and thus increase the pressure. In the second threaded length 28b the foaming gas, i.e. CO₂, as already mentioned, is injected into the cylindrical barrel 24 by means of the injection device.

A third threaded length 28c follows, in which the threading is configured to mix the molten plastic material with the foaming gas. In particular, along this length of the screw the threading has, for example, a constant pitch, preferably comprised in a range between 25 and 30 mm and an inclination of the flanks comprised in a range between 58° and 70°.

After the third threaded length 28c, each screw 28 comprises a fourth length 28d, in which the threading is configured to allow further mixing of the molten plastic material with the foaming gas injected into the cylindrical barrel 24. Preferably, along this length of the screw the thread has a variable pitch, for example from 25 to 45 mm.

Finally, each screw 28 comprises a fifth length 28e configured to push forward the plastic material in the end region of the cylindrical barrel 24, in which the plastic material begins to cool. Preferably, along this length of the screw the threading has a variable pitch, for example from 27 to 35 mm, and an inclination angle of the flanks of the teeth varying from 105° to 135°. To improve the cooling of the plastic material in the end region of the cylindrical barrel 24, a water circulation system at a controlled temperature is provided in this region. In particular, in this region of the cylindrical barrel 24 a temperature for example comprised between 90 and 110° C. is maintained, with a pressure comprised for example between 20 and 60 bar.

The plastic material that leaves the cylindrical barrel 24 passes through the head 36, which may take different configurations depending on the type of product to be obtained. The head 36 may be for example a flat head, suitable for the production of slabs, a round head, suitable for the production of films, or a head for profiles, suitable for the production of profiles of various shapes and sizes. Preferably, a filter (not shown, but in any case of a type known per se) for filtering the molten material before it enters the head 36 is interposed between the cylindrical barrel 24 and the head 36 so as to block any residual dirt present in the material.

The method for the production of foamed polymeric material carried out by using the apparatus 10 described above will now be described.

The feeding unit 14 feeds the extrusion machine 12 with a blend of plastic material suitably selected depending on the foamed material to be produced. The plastic material introduced into the extrusion machine 12 moves forward through the cylindrical barrel 24, under the action of the counter-rotating screws 28, being melted and mixed with CO₂ as a foaming gas. More specifically, in an initial section of the path along the cylindrical barrel 24 the plastic material introduced is heated by the heating elements 38 until it melts, then in an intermediate section of the path along the cylindrical barrel 24 the foaming gas is injected into the mass of plastic material and mixed with it. The mixture of plastic material and foaming gas thus obtained is cooled in the end region of the cylindrical barrel 24 and then leaves the extrusion machine 12 through the head 36.

The present invention has been described here with reference to a preferred embodiment thereof. It is to be understood that other embodiments may be provided sharing the same inventive core with the one described here, as defined by the scope of the enclosed claims.

1. An apparatus for the production of foamed polymeric material, in particular polyethylene and polypropylene, by means of a physical foaming process, the apparatus comprising an extrusion machine and a feeding unit for feeding the extrusion machine with a blend of plastic material,
wherein the extrusion machine comprises
a machine body,
a cylindrical barrel accommodated in the machine body and connected with a first end thereof to the feeding unit to receive from the feeding unit said blend of plastic material,
a pair of screws received in the cylindrical barrel and having axes of rotation arranged of parallel to each other,
a driving unit for driving the screws into rotation at a same speed, but in opposite directions, around their respective axes of rotation,
a gas tank for containing a foaming gas,
injection means for injecting the foaming gas coming from the gas tank into the cylindrical barrel,
a head mounted at a second end of the cylindrical barrel opposite to said first end, and
heating means arranged around the cylindrical barrel to transfer heat thereto,
wherein said gas tank contains carbon dioxide as a foaming gas.

2. The apparatus according to claim 1, wherein each screw comprises a plurality of threaded lengths having different configurations with respect to each other.

3. The apparatus according to claim 2, wherein said plurality of threaded lengths comprises, starting from the end opposite to the head, a first threaded length having a variable pitch.

4. The apparatus according to claim 3, wherein said plurality of threaded lengths further comprises, adjacent to said first threaded length, a second threaded length whose threading has a smaller pitch than that of said first threaded length.

5. The apparatus according to claim 4, wherein said injection means are configured to inject the foaming gas into the cylindrical barrel at said second threaded length of each of the screws.

6. The apparatus according to claim 4, wherein said plurality of threaded lengths further comprises, adjacent to said second threaded length, a third threaded length having a constant pitch.

7. The apparatus according to claim 6, wherein said plurality of threaded lengths further comprises, adjacent to said third threaded length, a fourth threaded length having a variable pitch.

8. The apparatus according to claim 7, wherein said plurality of threaded lengths further comprises, adjacent to said fourth threaded length, a fifth threaded length having a variable pitch.

9. A method for the production of foamed polymeric material, in particular polyethylene and polypropylene, by means of a physical foaming process in an apparatus according to claim 1, comprising the steps of:
a) feeding a blend of plastic material to be extruded into the extrusion machine through the feeding unit;
b) heating the plastic material inside the cylindrical barrel of the extrusion machine until melting by means of said heating means and causing said plastic material to move forward towards the head by means of the screws; and
c) in a longitudinally intermediate region of the cylindrical barrel injecting into the cylindrical barrel by means of said injection means carbon dioxide as a foaming gas.
